(19) United States
(12) Patent Application Publication
(10) Pub. No.: US 2020/0016924 A1
(43) Pub. Date: Jan. 16, 2020

(54) Paint Tray Roller

(71) Applicant: Jeff Leroy Burke, Rutland, VT (US)

(72) Inventor: Jeff Leroy Burke, Rutland, VT (US)

(21) Appl. No.: 16/033,241

(22) Filed: Jul. 12, 2018

(51) Int. Cl. B44D 3/12

(52) U.S. Cl. CPC B44D 3/126

(57) ABSTRACT

A paint tray roller system that has a paint tray with an upper circumferential land having an upwardly projecting dowel at each corner. A paint tray liner has a medial portion substantially conforming to an inside surface of the paint tray and a peripheral liner lip extending over the land makes painting and rolling walls much easier. The paint tray roller system has four wheels, giving the user flexibility and accessibility. The present invention is portable.

### BACKGROUND OF THE INVENTION

This invention may be described as an improved paint tray that is designed to allow for ease of use and tray mobility during the application of paint rolling; minimizing or eliminating spills during the painting process.

Paint trays are typically manufactured in three sizes: commercial size, residential size, and mini size. The present paint tray invention may be manufactured in any size, including the above mentioned three sizes. In a primary embodiment, the paint tray is intended for use as a standard sized, commercial paint tray, and may, as indicated above, house a paint tray liner, in either the opened or closed positions. Paint tray liners are also manufactured in a standard size, and which will house the roller portion of a standard sized paint tray roller with handle, along the width of said liner.

The paint tray is manufactured by a molding process, and preferably by thermal formed molding. The paint tray is composed essentially of a polymeric material, which is durable, chemically compatible with commercial paint, and strong enough to house a full paint well. Such polymeric materials include PETE, and material olefins, such as polyethylene, polypropylene, and clarified polypropylene if the paint tray is to also display products contained therein, such as a paint brush, paint roller with handle, and the like.

In some embodiments, a suitable colorant may be added to the polymeric formulation, to add the desired coloration to the paint tray. In some preferred embodiments of the paint tray, graphite particles or fibers may be added to the polymeric formulation, such as PETE, in order to achieve a non-stick quality to the tray body or to a similarly composed paint tray liner, if the paint should dry; in which case, the hardened paint could be knocked out of the tray body or the liner. A preferred embodiment of the paint tray would have a black or clear coloration, because the other colorations may interfere with the user's judgment in mixing paints and achieving the desired color or shade.

### DESCRIPTION OF RELATED ART

During the painting of large projects, commercial painters have found it advantageous to use paint rollers that are wider than the standard nine-inch residential paint roller. These commercial rollers are typically twice as wide as the standard rollers. The larger rollers allow painters to cover more wall area in less amount of time. The time saved by using a larger roller equates into increased profits for the commercial painter. To accommodate the wider roller, standard paint trays have been widened.

The prior art paint trays do not adequately allow the painter to evenly apply paint to the wider roller. Wet paint has a low viscosity and a low coefficient of friction. These characteristics of paint make it difficult to evenly apply paint to a roller. Instead of rotating up the ramp of the tray, the roller slides, leaving an uneven amount of paint on the roller.

Also, larger rollers are harder to manipulate in the prior art paint trays, often leaving excess paint on the ends of the roller, which drips onto the floors and walls in the rooms being painted. The prior art devices do not provide for a tray that allows for the proper application of paint to the roller.

### SUMMARY OF THE INVENTION

This invention may be described as a portable paint tray roller and holder with wheels that allow for a quicker and easier application of paint using a paint roller and tray. The invention has a central paint well and angled paint roller ramp, to allow for a paint tray insert, which allows the painter to easily change out paint trays. The invention includes four wheels that support the paint tray well off the ground and distribute the weight of the tray. This allows for portability while painting, including on carpeted surfaces.

A primary application of this invention is to offer the manufacturer a paint tray roller which is lightweight, yet strong, and inexpensive to manufacture, stackable when stockpiled in the open position, and in some preferred embodiments stackable when stockpiled in the closed position, with display goods, such as a paint brush and paint roller with handle, within the tray.

In accordance to another aspect of the present invention, there is provided a paint tray liner comprising: a pair of opposed side walls and a pair of opposed end walls defining a generally rectangular outline and a floor, said floor having a sloping floor portion extending from a sloping floor upper end at a first end wall of said liner to a sloping floor lower end terminating in a paint well extending from an opposite second end wall of said liner; a peripheral liner lip extending from a top edge of said side walls and said end walls, said liner lip having a hole at each of the four corners made by said end walls and side walls.

In accordance to a further aspect of the invention, there is provided with a paint tray lid comprising: a peripheral lid lip, said lid lip having four corner holes; and a bulge extending inwardly from an end of the said lid.

Other features and advantages will become apparent from the following description in conjunction with the drawings.

### BRIEF DESCRIPTION OF THE DRAWINGS

The drawing figures reflect a preferred embodiment of the paint tray roller, as is intended for use with a paint roller, but, the paint tray roller and its preferred embodiment is not limited to such use, and may, e.g. be used in a smaller or larger size, and with differing paint tools. The preferred embodiment of the paint tray, as shown in the drawing figures, is also intended for the optional use with a standard size paint tray liner, which will fit within the tray body of the paint tray.

FIG. 1 shows a front top view of the preferred embodiment of the paint tray roller, with a paint roller within said tray, and protruding from said tray.

FIG. 2 shows a side view of the preferred embodiment of the paint tray roller, without the paint roller and insert. FIG. 3 shows a top side full view of our Invention. FIG. 4 shows a side full view of our Invention.

### DETAILED DESCRIPTION OF THE INVENTION

While the present invention will be described fully hereinafter with reference to the accompanying drawings, in which a particular embodiment is shown, it is understood at the outset that persons skilled in the art may modify the invention herein described while still achieving the desired result of this invention. Accordingly, the description which follows is to be understood as a broad informative disclosure directed to persons skilled in the appropriate arts and not as limitations of the present invention.

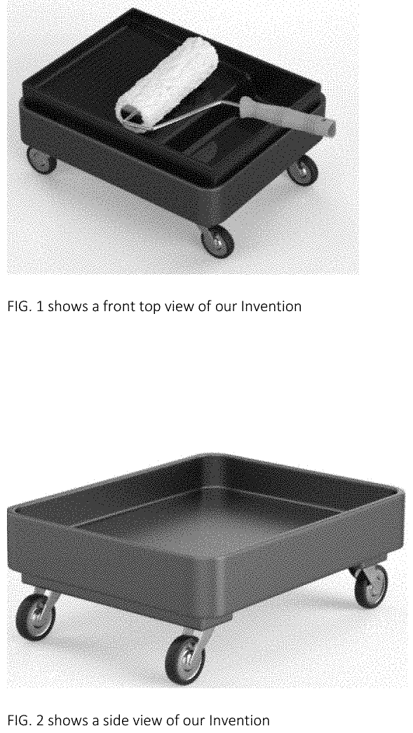

A preferred embodiment of the paint tray of the present invention is shown in FIG. 1. The paint tray is rectangular and includes a paint well and angularly inclined roller ramp. The roller ramp respectively drops off into the paint well. The paint well is located at the end of the paint tray and is designed to act as a reservoir and to allow paint to be placed therein for dipping a paint roller. The paint tray is preferably fabricated out of molded plastic, but other materials can be used. The preferred width for the tray is eighteen inches, which is the width of commercial paint rollers but can be sized to accommodate alternative sizes. The tray includes a right-side wall and a spaced apart left side wall. The paint well is rectangular in shape and is defined by the right-side wall and left side wall of the paint tray as well as the bottom edges and of the roller ramp. The paint well is dimensioned to hold a large quantity of paint, as for example half a gallon, so the well can be filled less frequently.

The roller ramp is located on the opposing side of the paint well and provides a surface for evenly applying the paint to the roller. The roller ramp is sloped upward as it approaches the opposing end of the tray. The roller ramp is designed so that excess paint can be removed from the roller and can drain back into the paint well. The ramp includes evenly spaced traction ridges. During the normal use of a paint tray, the roller ramp becomes covered with wet paint. When the paint roller is dipped into the paint well, paint is only applied to one half of the roller. The paint on the roller is evened out by rolling it up and down the ramp.

Due to the inherent nature of paint, the roller ramp becomes slippery, preventing the paint roller from rotating on the ramp. Also, the paint on one side of the roller creates an uneven weight balance, discouraging full rotation of the roller on the ramp. The traction ridges of the present invention aid in the rotation of the roller as it moves up and down the ramp. The traction ridges are designed to engage the nap of the roller, allowing the roller to freely move up and down the ramp.

By using traction ridges to engage the nap of the roller, even paint coverage on the roller is possible. It is not necessary the that the ridges be painted but any configuration of projection that will engage the nap of the roller and cause it to rotate, rather than slide, as it moves up and down the ramp will be sufficient for purposes of the present invention. On the outside edge of the roller ramp are drainage channels, positioned between the side wall and the side edge of the ramp, that allow paint from the edges of the rollers to drain back to the paint well without accumulating near the ends of the roller.

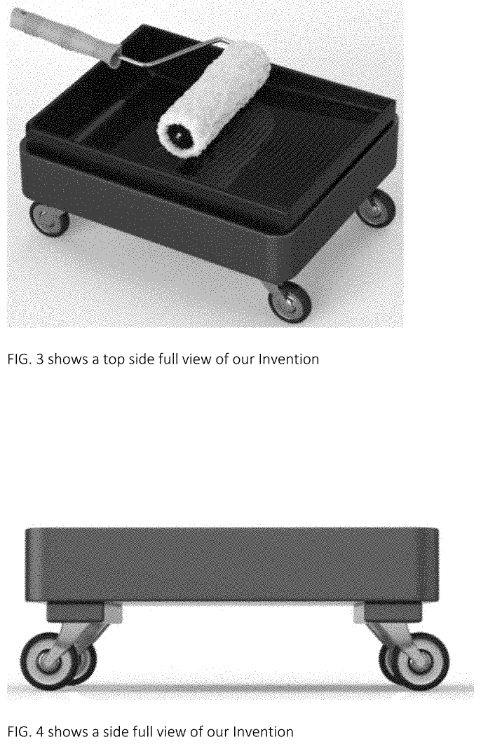

The paint tray roller also has four outboard wheels, one located at each corner of the tray as shown in FIGS. 1 and 2, that are used to support, as shown in FIG. 1, to elevate the entire tray off the ground or other support surface. The weight of the tray is evenly distributed over the four wheels. Since the wheels have a smaller surface area than the bottom of the paint well, the force per unit of surface area exerted onto the ground is increased. This increase in force aids in preventing the tray from moving when the roller is rolled up and down the ramps.

Various features of the invention have been particularly shown and described in connection with the illustrated embodiment of the invention, however, it must be understood that these particular arrangements merely illustrate, and that the invention is to be given its fullest interpretation within the terms of the appended claims.

1. A paint tray roller with wheels for use with a paint roller comprising: a central paint well adapted to contain paint; an inclined roller ramp extending outwardly and upwardly from said paint well; a plurality of traction ridges extending upwardly from said ramp for engagement with the roller; whereby said paint tray allows for a proper application of paint to the roller with portability.

2. The paint tray of claim 1, wherein said paint tray roller includes wheels to support said tray well-off of the ground.

3. The paint tray roller of claim 2, wherein said wheels supports include a plurality of braces to stabilize supports and movement over varied surfaces.

4. The paint tray roller of claim 3, wherein said leg supports are adapted to accept wheels to raise said tray off the ground.

5. A paint tray roller as in claim 1 including first and second side walls and a paint channel defined between said roller ramp and one of the said side walls, said channel operative to allow paint removed from a roller end to flow back to said central paint well.

6. A paint tray roller for use with a paint roller comprising: a paint well adapted for containing paint; at least one roller ramp extending outwardly and upwardly from said paint well; first and second drainage channels positioned one each side of said roller ramp to allow for the drainage of paint; said roller ramp includes a plurality of traction ridges adapted to engage the paint roller.

7. The paint tray roller of claim 6, wherein said at least one roller ramp includes a plurality of traction ridges adapted to engage the roller.
